(19) United States
(12) Patent Application Publication
(10) Pub. No.: US 2024/0253753 A1
(43) Pub. Date: Aug. 1, 2024

(54) SYSTEM AND METHOD FOR USING AUTONOMOUS UNDERWATER VEHICLES FOR OCEAN BOTTOM SEISMIC NODES

(71) Applicant: PXGEO UK Limited, Bristol (GB)

(72) Inventors: Martin John Hartland, Katy, TX (US); Nishan Ragoonanan, Houston, TX (US); Ian Roberts, Houston, TX (US)

(73) Assignee: PXGEO UK Limited, Bristol (GB)

(21) Appl. No.: 18/427,110

(22) Filed: Jan. 30, 2024

Related U.S. Application Data
(60) Provisional application No. 63/482,682, filed on Feb. 1, 2023.

(51) Int. Cl. B63C 7/16; B63B 27/10; B63B 35/40; B63G 8/00; B63G 8/08; B63G 8/14; B63G 8/38

(52) U.S. Cl. CPC B63C 7/16; B63B 27/10; B63B 35/40; B63G 8/001; B63G 8/08; B63G 8/14; B63G 8/38; B63G 2008/004; B63G 2008/008

(57) ABSTRACT

A system and method for deploying and retrieving a plurality of ocean bottom seismic nodes to and from the seabed. An autonomous underwater vehicle (AUV) is coupled to a node skid that is configured to handle the nodes. The AUV and coupled skid is lowered to and raised from the seabed and a surface vessel in a garage or basket. The skid may have a variable buoyancy system (VBS) formed of a plurality of pipes and a positive displacement pump, such that the VBS is configured to automatically control a buoyancy of the skid. The AUV and/or skid has a plurality of cameras for optical 3D stereo photogrammetry for identification, deployment, and retrieval of the nodes. Also disclosed is a method for retrieving a dead AUV from the ocean bottom by utilizing a garage and an unmanned underwater vehicle (UUV).

### BACKGROUND OF THE INVENTION

### Priority

This application claims priority to U.S. provisional patent application No. 63/482,682, filed on Feb. 1, 2023, the entire contents of which is incorporated herein by reference.

### Field of the Invention

This invention relates to the deployment and recovery of seismic nodes by an underwater vehicle, and more particularly relates to the identification, tracking, deployment, and recovery of ocean bottom seismic nodes during subsea operations by an autonomous underwater vehicle.

### Description of the Related Art

Marine seismic data acquisition and processing generates a profile (image) of a geophysical structure under the seafloor. Reflection seismology is a method of geophysical exploration to determine the properties of the Earth's subsurface, which is especially helpful in determining an accurate location of oil and gas reservoirs or any targeted features. Marine reflection seismology is based on using a controlled source of energy (typically acoustic energy) that sends the energy through seawater and subsurface geologic formations. The transmitted acoustic energy propagates downwardly through the subsurface as acoustic waves, also referred to as seismic waves or signals. By measuring the time it takes for the reflections or refractions to come back to seismic receivers (also known as seismic data recorders or nodes), it is possible to evaluate the depth of features causing such reflections. These features may be associated with subterranean hydrocarbon deposits or other geological structures of interest.

In general, either ocean bottom cables (OBC) or ocean bottom nodes (OBN) are placed on the seabed. Marine seismic surveys need a fast and cost-effective system for deploying and recovering autonomous seismic receivers that are configured to operate underwater. One conventional method for the deployment of OBNs is to deploy a ROV in a body of water while also deploying a separate underwater node transfer device, such as a basket, that is configured to hold a plurality of seismic nodes and be lowered and raised from a surface vessel. At a certain subsea position, the ROV docks or mates with the node transfer device and transfers one or more nodes from the node transfer device to the ROV. The ROV then places the retrieved nodes at one or more positions on the seabed. Prior art patents and publications illustrating the use of an ROV or AUV to deploy or retrieve ocean bottom seismic nodes include at least the following: U.S. Pat. Nos. 6,975,560; 7,210,556; 7,324,406; 7,632,043; 8,310,899; 8,611,181; 9,415,848; 9,784,873; 9,873,496; 9,969,470; 10,099,760; 11,059,552, and 11,442,191, each of which is incorporated herein by reference. Still further, prior art patents also disclose the touch down monitoring of an ocean bottom seismic node by an autonomous underwater vehicle (AUV). See, e.g., U.S. Pat. No. 9,891,333. An ROV typically uses a TMS connected to a surface vessel for power and communications, which allows the ROV to travel up to 1300 meters from a TMS position. Distinct from an AUV is a remotely operated vehicle (ROV). In general, the structure and operation of marine ROVs are well known to those of ordinary skill. For example, Publication No. WO2014/090811, incorporated herein by reference, describes a ROV configured to deploy and retrieve autonomous seismic nodes to the seabed with a separate AUV configured to monitor and exchange data with the seismic nodes. Likewise, U.S. Pat. No. 8,075,226, incorporated herein by reference, describes a ROV configured to physically deploy autonomous seismic nodes from a carrier located on the ROV as well as a basket lowered by a surface vessel and to mechanically connect the ROV to the lowered basket to transfer nodes from the basket to the ROV carrier.

The prior art systems for identifying, handling, and deploying seismic nodes from a surface vessel, underwater basket, and/or underwater vehicle are problematic. The closest prior art to the disclosed embodiments is the use of a ROV to individually handle seismic nodes, such as those described in U.S. Pat. Nos. 9,969,470 and 11,442,191, incorporated herein by reference. Such ROVs are electrically connected to the surface by an armored umbilical and electrically driven by a hydraulic power unit. Such ROVs are typically deployed by use of a Tether Management System (TMS) that utilizes a near neutral tether to allow the ROV to travel up to 1300 meters radially from the TMS position. When multiple ROVs are used, each ROV has a deployment line with operational issues of its own. Such existing systems generally fail to individually identify, manage, handle, and/or deploy seismic nodes. Such systems are not automated, costly, and slow. There is a continued need to improve efficiencies for ocean bottom seismic node deployment and retrieval.

The referenced shortcomings are not intended to be exhaustive, but rather are among many that tend to impair the effectiveness of previously known techniques in seafloor deployment systems; however, those mentioned here are sufficient to demonstrate that the methodologies appearing in the art have not been satisfactory and that a significant need exists for the systems, apparatuses, and techniques described and claimed in this disclosure.

A need exists for an improved method and system for deploying and recovering ocean bottom seismic nodes to and from the seabed from an underwater vehicle. A need exists to reduce operating costs, reduce HSE exposure, and improve operating efficiency. A need exists for an enhanced remotely operated vehicle that for such deployment and recovery operations.

### SUMMARY OF THE INVENTION

A system and method for deploying and retrieving a plurality of ocean bottom seismic nodes to and from the seabed. An autonomous underwater vehicle (AUV) is coupled to a node skid that is configured to handle the nodes. The AUV and coupled skid is lowered to and raised from the seabed and a surface vessel in a garage or basket. The skid may have a variable buoyancy system (VBS) formed of a plurality of pipes and a positive displacement pump, such that the VBS is configured to automatically control a buoyancy of the skid. The AUV and/or skid has a plurality of cameras for optical 3D stereo photogrammetry for identification, deployment, and retrieval of the nodes. Also disclosed is a system and method for individually identifying, handling, tracking, deploying, and recovering the seismic nodes by the AUV. Also disclosed is a method for retrieving a dead AUV from the ocean bottom by utilizing a garage and an unmanned underwater vehicle (UUV).

Disclosed is a subsea system for the subsea transfer of a plurality of ocean bottom seismic nodes, comprising an autonomous underwater vehicle (AUV) comprising a power source and a plurality of thrusters and a skid configured to be removably attached to the AUV, wherein the skid is configured to hold a plurality of ocean bottom seismic nodes. The skid may comprise a node manipulator configured to transfer each of the plurality of seismic nodes to and from the seabed. The skid and/or AUV may comprise one or more cameras configured to take pictures of the seabed and/or the seismic nodes. The subsea system may also comprise an AUV garage configured to be raised to and lowered from a surface vessel and the seabed, wherein the AUV garage is configured to hold the AUV and the skid. The AUV will contain other components known to those of skill in the art that are not necessarily unique to the present disclosure.

The node skid may comprise a variable buoyancy system (VBS) that is configured to control a buoyancy of the skid based on a node payload of the skid. The VBS may comprise any one or more pressure chambers, vessels, tubes, or pipes. In one embodiment, the VBS comprises a plurality of pipes and a positive displacement pump. In one embodiment, the VBS is configured to inject and discharge water from the VBS to maintain a substantially constant and/or neutral weight of the node skid and/or coupled AUV and node skid during node deployment and/or retrieval operations.

Also disclosed is a method for the deployment of a plurality of ocean bottom seismic nodes on or near the seabed, comprising deploying an autonomous underwater vehicle (AUV) from a back deck of a marine surface vessel, wherein the AUV is coupled to a node skid comprising a plurality of ocean bottom seismic nodes, automatically locating a pre-plot position for each of the plurality of ocean bottom seismic nodes, automatically positioning the AUV proximate to the pre-plot position, such as by using a position derived by an onboard Inertial Navigation System (INS) of the AUV and a combined Doppler Velocity Log (DVL), automatically deploying a selected one of the plurality of ocean bottom seismic nodes at the pre-plot position, automatically recording a touchdown position of the deployed seismic node, and automatically adjusting a buoyancy of the node skid based on a node payload of the node skid to maintain a substantially neutral buoyancy in water. The method may also comprise injecting water into one or more pressurized chambers of the node skid to vary the weight of the skid to account for the node payload. The touchdown position may also comprise position coordinates, depth, and azimuth of the node. The method may further comprise automatically associating the touchdown position of the node with a unique identification number of the node. The recording step may comprise taking a picture of the node on the seabed by cameras on the AUV and/or skid. The method step may further comprise deploying the AUV and the node skid from the surface vessel in an AUV garage, wherein the AUV garage is configured to be raised and lowered from the surface vessel. The method step may further comprise utilizing one or more cameras as a multi-beam echo sounder to scan the seabed.

Also disclosed is a method for the recovery of a plurality of ocean bottom seismic nodes from the seabed, comprising positioning an autonomous underwater vehicle (AUV) near the seabed, wherein the AUV is coupled to a node skid configured to hold a plurality of ocean bottom seismic nodes, automatically locating a seabed position for each of the plurality of ocean bottom seismic nodes, automatically positioning the AUV proximate to the seabed position for each of the plurality of ocean bottom seismic nodes, automatically recovering each of the plurality of seismic nodes into the node skid by a manipulator arm, and automatically adjusting a buoyancy of the node skid based on a node payload of the node skid to maintain a substantially neutral buoyancy in water. The method may also include removing water from one or more pressurized chambers of the node skid to vary the weight of the skid to account for the node payload. The method may further comprise utilizing one or more cameras on the AUV or skid to automatically locate each of the plurality of ocean bottom seismic nodes on the seabed. The method may further comprise utilizing one or more cameras to determine the orientation of each of the plurality of ocean bottom seismic nodes on the seabed. The method may further comprise utilizing one or more cameras as a multi-beam echo sounder to scan the seabed.

Also disclosed is a method for recovery of a dead autonomous underwater vehicle (AUV) from on or near the seabed, comprising deploying a garage from a back deck of a marine surface vessel at a position proximate to the seabed, deploying an unmanned underwater vehicle (UUV) from the back deck of the marine surface vessel, positioning the UUV near the dead AUV, coupling the UUV to the dead AUV, coupling the dead AUV to the garage, and raising the garage to the back deck of the marine surface vessel with the coupled dead AUV. The method may further comprise deploying the UUV in the garage from the back deck of the marine vessel. The method may further comprise positioning the dead AUV within the garage by the UUV.

Also disclosed is a method for imaging the seabed, comprising positioning an autonomous underwater vehicle (AUV) near the seabed, wherein the AUV comprises a power source, a plurality of thrusters, and a plurality of cameras, scanning the seabed by utilizing stereo photogrammetry based on one or more camera images obtained by the plurality of cameras, imaging the seabed by utilizing point cloud recognition, and identifying objects on the seabed by using a neural network based on the one or more camera images.

Also disclosed is an autonomous underwater vehicle (AUV) for the subsea transfer of a plurality of ocean bottom seismic nodes, comprising a power source, a propulsion system configured to propel and steer the AUV while travelling underwater, wherein the propulsion system comprises a plurality of thrusters, and a variable buoyancy system (VBS) configured to control a buoyancy of the AUV based on a payload of the AUV. The AUV is configured hold a plurality of ocean bottom seismic nodes. The AUV is configured to move each of the plurality of ocean bottom seismic nodes to and from the seabed, such as by a node manipulator arm. The AUV may have one or more cameras configured to take pictures of the seabed.

Also disclosed is a subsea system for the subsea transfer of a plurality of ocean bottom seismic nodes, comprising an autonomous underwater vehicle (AUV) comprising a power source and a plurality of thrusters, and a skid embedded to the AUV, wherein the skid is configured to hold a plurality of ocean bottom seismic nodes, wherein the AUV comprises a node manipulator configured to transfer each of the plurality of seismic nodes to and from the seabed, wherein the AUV comprises a variable buoyancy system (VBS) configured to control a buoyancy of the skid based on a payload of the skid. Cameras may be located on the AUV or skid to take pictures of the seabed and seismic nodes.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-1F illustrate one embodiment of an autonomous underwater vehicle (AUV) for the handling of ocean bottom seismic nodes according to one embodiment of the present disclosure.

FIGS. 2A-2C illustrate one embodiment of an AUV coupled to a node skid that can be positioned within a garage or basket, according to one embodiment of the present disclosure.

FIGS. 3A-3C illustrate one embodiment of handling an AUV and the associated garage on the back deck of a marine vessel according to one embodiment of the present disclosure.

FIGS. 4A-4B illustrate one embodiment of deploying an AUV from a back deck of a marine vessel according to one embodiment of the present disclosure.

FIGS. 5A-5E illustrates one embodiment of retrieving an inoperable AUV from the seabed according to one embodiment of the present disclosure.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### Overview

In one or more embodiments, an autonomous underwater vehicle (AUV) is used to deploy or retrieve seismic nodes from the ocean bottom. An AUV in the following description is considered to encompass an autonomous self-propelled underwater vehicle. In general, the structure and operation of an AUV and seismic AUV is well known to those of ordinary skill. For example, Applicant's U.S. Pat. No. 9,090,319, incorporated herein by reference, discloses one type of autonomous underwater vehicle for marine seismic surveys. Other AUVs are also known, such as U.S. Pat. No. 9,891,333, incorporated herein by reference. An AUV may or may not incorporate seismic sensors. A HAUV may be considered as a hovering autonomous underwater vehicle and may be equivalently referred to as an unmanned underwater vehicle (UUV). For the purposes herein, the terms AUV and HAUV are used interchangeably. As disclosed herein, the AUV (which may refer to a UUV or a HAUV) does not require an electrical connection for power or communications to a surface vessel. The AUV may contain its own power source (e.g., batteries). The AUV is autonomous in that it is pre-programmed to execute a series of subsea tasks. As a result, the disclosed AUV can be fully disconnected from a surface vessel and can travel faster between seabed node positions than a traditional ROV/AUV approach. Communications with the AUV may be maintained from the surface vessel (as the surface vessel is normally within acoustic range of the AUV) and the monitoring and control approach can be considered as supervised autonomy. In other embodiments, the AUV may be operated fully independently of a surface vessel, such as a surface platform launch facility. The AUV is configured to store, transport, and handle ocean bottom seismic nodes to and from the seabed and the AUV. In some embodiments, the disclosed AUV may comprise or be coupled to a separate node skid for the transport and/or handling of seismic nodes. In some embodiments, the disclosed AUV may be transferred to and from the seabed by the use of a garage or basket that is lowered and raised from a surface vessel.

An autonomous seismic node is well known in the art. The disclosed AUV does not necessarily depend on a particular design or configuration of a seismic node. In general, autonomous ocean bottom nodes are independent seismometers, and in a typical application they are self-contained units comprising a housing, frame, skeleton, or shell that includes various internal components such as geophone and hydrophone sensors, a data recording unit, a reference clock for time synchronization, and a power source. The power sources are typically battery-powered, and in some instances the batteries are rechargeable. In operation, the nodes remain on the seafloor for an extended period of time. Once the data recorders are retrieved, the data is downloaded and batteries may be replaced or recharged in preparation of the next deployment. Various designs of ocean bottom autonomous seismic nodes are well known in the art. Autonomous nodes include spherical shaped nodes, cylindrical shaped nodes, disk shaped nodes, and square shaped nodes. Some of these devices and related methods are described in more detail in the following patents, incorporated herein by reference: U.S. Pat. Nos. 6,024,344; 7,310,287; 7,675,821; 7,646,670; 7,883,292; 8,427,900; 8,675,446; and 9,523,780. In one embodiment, the seismic nodes utilized by the disclosed AUV are Applicant's MANTA nodes, which may be substantially similar to the seismic node described in U.S. Pat. Nos. 9,494,700 and 9,523,780, incorporated herein by reference.

In one embodiment, the disclosed AUVs are deployed and retrieved from a back deck of a marine vessel. Such marine vessels and back decks are well known to those in the art. The back deck may comprise a plurality of containerized shipping containers that holds the seismic nodes, skid deck loader units, servers, and other necessary equipment on the back deck of the marine vessel, as disclosed in U.S. Pat. Nos. 9,784,873 and 9,459,366, incorporated herein by reference. The back deck of the vessel may comprise conventional LARS unit for the deployment of ROVs, AUVs, and baskets to the seabed. A plurality of AUVs and subsea garages may be placed on the surface of the vessel during deployment and retrieval operations. In one embodiment, when the garage is landed on the back deck, it fully interfaces with the containerized deployment system for handling of the AUVs, autonomous seismic nodes, and/or coupled skids, and the autonomous seismic nodes can be washed, recharged, stored, and data transferred.

Applicant's U.S. Patent Publication 2019/0265378, entitled Automated Ocean Bottom Seismic Node Identification, Tracking, Deployment, and Recovery System and Method, is incorporated herein. Such a system discloses an ROV coupled to a subsea basket that carries nodes in the basket. The identification system is configured to track, select, deploy, and recover a particular seismic node by its unique identification number. The present application discloses an AUV instead of an ROV and a unique skid for coupling to the AUV for deployment and recovery to the seabed.

### Autonomous Underwater Vehicle

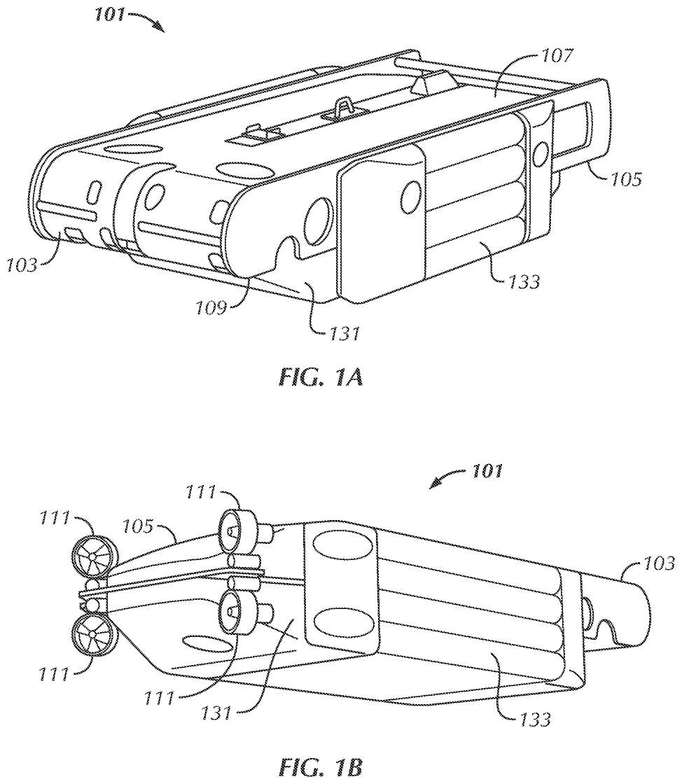

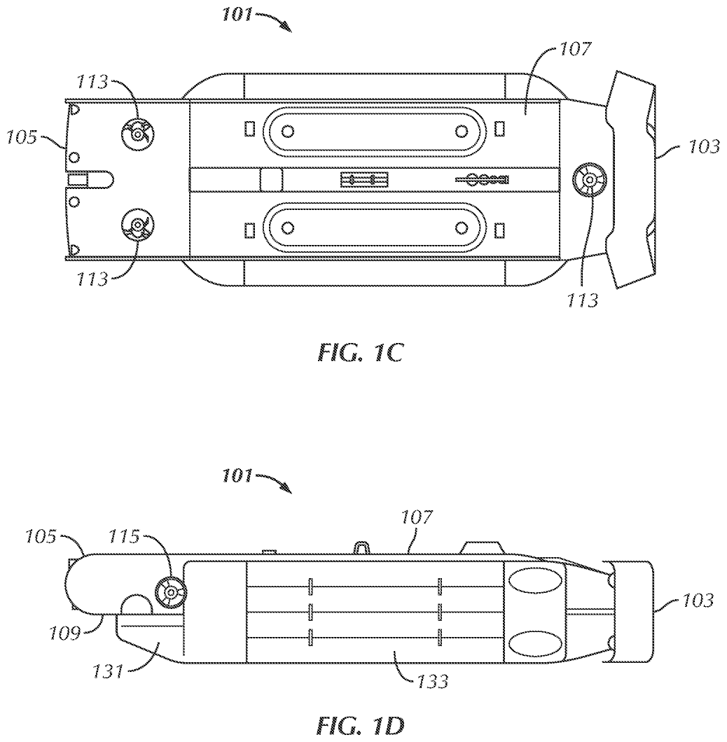

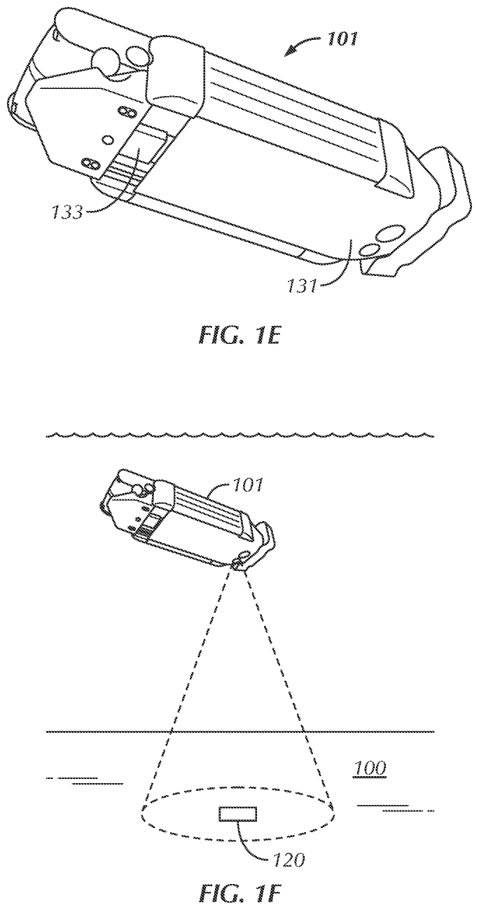

FIGS. 1A-1D disclose one embodiment of an AUV according to the present disclosure. In one embodiment, an AUV may comprise a body with a propulsion system, a guidance system, an acoustic system, and a navigation system. The overall shape and design of the AUV is not necessarily important, as long as it is configured to travel subsea and couple with the disclosed node skid. In one embodiment, the disclosed AUV may be substantially similar in function to that disclosed in U.S. Pat, No. 9,891,333, incorporated herein by reference; such AUV components and AUV acoustic technology are well known in the art and are discussed in more detail below.

Referring to FIG. 1A, AUV 101 may comprise front portion 103, back portion 105, upper portion 107, and lower portion 109. Referring to FIG. 1B, the AUV may comprise horizontal thrusters 111, which may be positioned at or near back portion 105. Referring to FIG. 1C, the AUV may comprise vertical thrusters 113, which may be positioned at either the front portion 103 and/or back portion 105 of the AUV. Referring to FIG. 1D, the AUV may comprise side thrusters 115, which may be positioned at the back portion 105 of the AUV.

As disclosed herein, the AUV is configured to hold a plurality of ocean bottom seismic nodes. The nodes can be located within the AUV itself, or can be handled by a separate node skid coupled to the AUV that may be removably attachable to the AUV. In still other embodiments, the node skid may be an integral or embedded part of the AUV such that the AUV and node skid are essentially considered a single unit. In general, a node skid, as described herein, is coupled to the AUV and holds a plurality of ocean bottom seismic nodes. The disclosed node skid may be removably attached to the AUV, and may comprise a variable buoyancy system as disclosed in more detail herein. Referring to FIGS. 1A-1D, node skid 131 is illustrated as being coupled in shape and form to AUV 101. In one embodiment, node skid 131 is coupled to the underside portion of the AUV, and may also be coupled to or formed around the sides of the AUV. In one embodiment, node skid 131 comprises a plurality of horizontal pipes 133, which may be located on one or more sides of the AUV/skid and/or on the middle of the skid such that when coupled with the AUV, pipes 133 may be located underneath the AUV.

In one embodiment, the AUV may comprise a propulsion system that may include one or more propellers or thrusters. A motor inside the AUV body may activate the propellers. Other propulsion systems may be used, e.g., jets, thrusters, pumps, etc. For example, the AUV may include one or more vertical thrusters (for vertical lift) and a plurality of horizontal thrusters (for lateral movement). The AUV may include one or more fins or wings for flight stabilization and/or increased AUV control. A motor may be controlled by a processor/controller. A processor may also be connected to a memory unit and tracking system, which may be configured for tracking the deployed cable and/or seismic nodes. One or more batteries may be used to power all these components.

The AUV may also include an inertial navigation system (INS) configured to guide the AUV to a desired location. An inertial navigation system includes at least one module containing accelerometers, gyroscopes, magnetometers or other motion-sensing devices. The INS is initially provided with the position and velocity of the AUV from another source, for example, a human operator, a global positioning system (GPS) satellite receiver, another INS from a surface vessel, etc., and thereafter, the INS computes its own updated position and velocity by integrating (and optionally filtering) information received from its motion sensors. The advantage of an INS is that it requires no external references in order to determine its position, orientation, or velocity once it has been initialized. As noted above, alternative systems may be used, as, for example, acoustic positioning systems. An optional acoustic Doppler Velocity Log (DVL) (not shown) can also be employed as part of the AUV, which provides bottom-tracking capabilities for the AUV. Sound waves bouncing off the seabed can be used to determine the velocity vector of the AUV, and combined with a position fix, compass heading, and data from various sensors on the AUV, the position of the AUV can be determined. This assists in the navigation of the AUV and provides confirmation of its position relative to the seabed.

Besides or instead of an INS, the AUV may include a compass and other sensors, such as, for example, an altimeter for measuring its altitude, a pressure gauge, an interrogator module, a homing beacon, etc. The AUV may optionally include an obstacle avoidance system and a communication device (e.g., Wi-Fi device, a device that uses an acoustic link) or another data transfer device capable of wirelessly transferring data. One or more of these elements may be linked to the processor. The AUV further includes an antenna (which may be flush with the body of the AUV) and corresponding acoustic system for subsea communications, such as communicating with the deploying, shooting, or recovery vessel (or other surface vessel) or an underwater base/station, ROV, or another AUV, or even the deployed nodes themselves. For surface communications (e.g., while the AUV is on a ship), one or more of antenna and communication devices may be used to transfer data to and from the AUV. Stabilizing fins and/or wings for guiding the AUV to the desired position may be used together with a propeller for steering the AUV. However, in one embodiment, the AUV has no fins or wings. The AUV may include a buoyancy system for controlling the AUV's depth and keeping the AUV steady after landing. In some embodiments, the AUV is neutrally buoyant in a body of water, whereas in other embodiments it may be positively buoyant or negatively buoyant. Those skilled in the art would appreciate that more or less modules or components may be added to or removed from the AUV based on the particular needs of the AUV.

The acoustic system utilized by the AUV may be an Ultra Short Baseline (USBL) system, sometimes known as a Super Short Base Line (SSBL). This system uses a method of underwater acoustic positioning. A complete USBL system includes a transceiver or acoustic positioning system mounted on a pole under a vessel (such as Hi-PAP, commercially available by Kongsberg) and a transponder on the AUV. In general, a hydro-acoustic positioning system consists of both a transmitter (transducer) and a receiver (transponder). An acoustic positioning system uses any combination of communications principles for measurements and calculations, such as SSBL. In one embodiment, the acoustic positioning system transceiver comprises a spherical transducer with hundreds of individual transducer elements. A signal (pulse) is sent from the transducer, and is aimed towards the seabed transponder. This pulse activates the transponder, which responds to the vessel transducer. The transducer detects this return pulse and, with corresponding electronics, calculates an accurate position of the transponder relative to the vessel based on the ranges and bearing measured by the transceiver. In one embodiment, to calculate a subsea position, the USBL system measures the horizontal and vertical angles together with the range to the transponder (located in the AUV in a typical SSBL configuration) to calculate a 3D position projection of the AUV relative the vessel. An error in the angle measurement causes the position error to be a function of the range to the transponder, so an USBL system has an accuracy error increasing with the range. Alternatively, a Short Base Line (SBL) system, an inverted short baseline (iSBL) system, or an inverted USBL (iUSBL) system may be used, the technology of which is known in the art. For example, in an iUSBL system, the transceiver is mounted on or inside the AUV while the transponder/responder is mounted on the surface vessel or ROV and the AUV has knowledge of its individual position rather than relying on such position from a surface vessel (as is the case in a typical USBL system). In another embodiment, a long baseline (LBL) acoustic positioning system may be used. In a LBL system, reference beacons or transponders are mounted on the seabed around a perimeter of a work site as reference points for navigation. The LBL system may use an USBL system to obtain precise locations of these seabed reference points. Thus, in one embodiment, the reference beacon may comprise both an USBL transponder and a LBL transceiver. The LBL system results in very high positioning accuracy and position stability that is independent of water depth, and each AUV can have its position further determined by the LBL system. The acoustic positioning system may also use an acoustic protocol that utilizes wideband Direct Sequence Spread Spectrum (DSSS) signals, which provides for a greater communications range in the water.

FIGS. 1E and 1F illustrate AUV 101 in operation. For example, FIG. 1E shows AUV from an underneath perspective, with node skid 131 being coupled to the underneath of the AUV. A front portion 133 of the node skid is opened, through which seismic nodes can be deployed from the AUV and/or node skid. In some embodiments, a node manipulator arm may be coupled to the AUV or node skid to help handle the seismic nodes. In some embodiments, the AUV may contain a tooling compartment that is within the node skid or within an external form of the AUV. FIG. 1F shows the AUV proximate to seabed 100 and scanning for seismic node 120 positioned on the seabed. As described herein, various sensors or cameras can be utilized by the AUV or node skid to scan the seabed, obtain information on the node and seabed, and/or to identify the particular seismic node.

### Skid for Node Handling

In general, a node skid, as described herein, is coupled to the AUV and holds a plurality of ocean bottom seismic nodes. The disclosed node skid may be removably attached to the AUV, and may comprise a variable buoyancy system as disclosed in more detail herein. In other embodiments, the node skid may be permanently attached embedded within the AUV. In still other embodiments, the AUV may comprise a large belly or void to hold the seismic nodes and to to achieve the same functionality of the disclosed node skid without having a separate node skid.

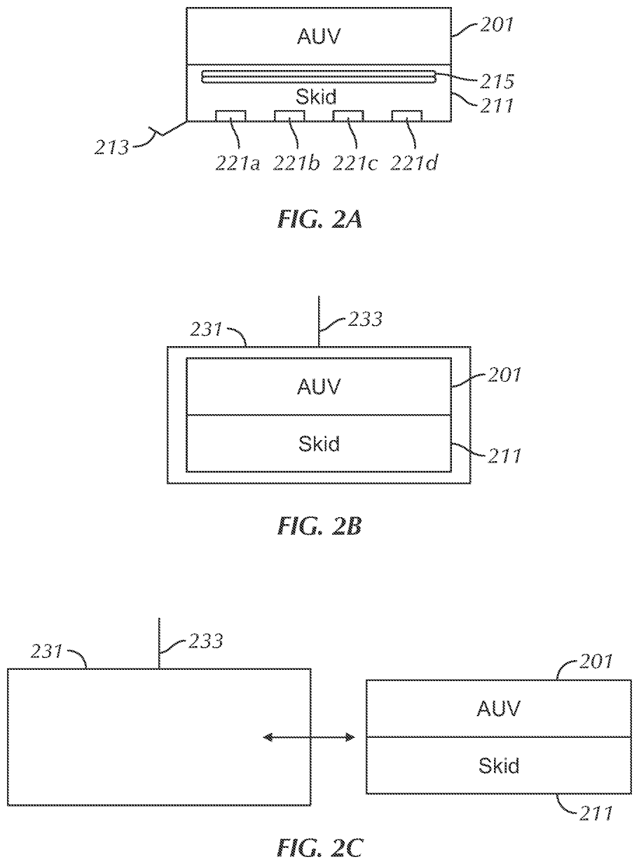

One schematic of a coupled node skid, as disclosed herein, is illustrated in FIGS. 2A-2C. This may be substantially similar to node skid 131 as illustrated in FIGS. 1A-1D. Referring to FIG. 2A, AUV 201 may be coupled to node skid 211. Node skid 211 is configured to hold a plurality of ocean bottom seismic nodes 221a-221d. Node skid 211 may comprise one or more manipulator arms 213. One or more cameras (not shown) may also be located on the node skid. In one embodiment, the node skid comprises variable buoyancy system 215, which may comprise a plurality of pipes and a water displacement pump, discussed in greater detail below. Referring to FIG. 2B, the AUV and coupled node skid may be positioned within garage or basket 231 for handling or transport purposes. Referring to FIG. 2C, garage 231 may be lowered and raised from a marine surface vessel via tether 233. As also illustrated in FIG. 2C, the AUV and coupled node skid may be deployed from the garage for subsea operations.

The node skid and/or AUV is configured to transport and/or handle the seismic nodes to and from the seabed. In general, the disclosed skid may also be considered a platform, garage, or basket, as is known in the art. In one embodiment, the AUV is configured to travel subsea and a plurality of seismic nodes are positioned on the skid. In one embodiment, the skid can be attached to or detached from the AUV on the back deck of the marine vessel, in the sea, or on the seabed. The AUV and coupled skid may travel to and from the seabed and surface vessel with or without nodes. In the past, remotely operated vehicles (ROVs) have offered similar but different configurations and methods, such as those described in U.S. Pat. Nos. 6,975,560; 7,210,556; 7,324,406; 7,632,043; 8,310,899; 8,611,181; 9,090,319; 9,415,848; and 9,873,496, incorporated herein by reference. In one embodiment, the skid is removably attached to the AUV, whereas in other embodiments the node skid is integrally formed and/or a part of the AUV. For example, the AUV may have a large belly or void space on the bottom in which the seismic nodes may be stored within and transferred to and from, as opposed to having a separate node skid removably attachable to the AUV. In one embodiment, the disclosed AUV need not actually handle the nodes itself, but rather moves the skid to the operable position subsea and/or on the seabed. In one embodiment, the skid has its own power source, while in other embodiments the skid utilizes a power source on the AUV when they are coupled together.

In one embodiment, the disclosed skid is a platform that can be coupled to the disclosed AUV. The skid may be configured to handle up to 50 seismic nodes or more, each with a payload of up to 25 kg in water. In general, a skid is separate from the AUV may be coupled and/or integrated with the AUV for power, control, and movement. It may be mounted beneath the AUV and secured with a plurality of fasteners, such as flanges or pins. It may be substantially cuboid or rectangular in shape, and may be streamlined to reduce drag. In one embodiment, the skid incorporates an integrated and automatic XYZ manipulator to position nodes to and from a storage position on the skid to the seabed. The manipulator may be integrated with a mission control system on the AUV for automatic control. As the seismic nodes need to be handled, the mission control system for the AUV and/or skid automatically handles the nodes at the appropriate time. The skid may be substantially neutrally buoyant in water, and may be formed of a flotation material and/or syntactic foam to keep the skid near neutral in the water. In one embodiment, the skid may comprise a variable buoyancy system (discussed in more detail below) to maintain the weight in water close to zero for the skid no matter the skid payload as it is deploying and retrieving nodes.

In one embodiment, the disclosed skid incorporates one or more cameras to target the seabed for identification of the seismic nodes and position of the nodes on the seabed. In one embodiment, the skid comprises two vertically down facing fixed cameras that are spaced apart a predetermined distance (such 30 centimeters or more). In one embodiment, the XYZ manipulator is positioned between equal distance from both of the cameras and is a fixed offset from the AUV navigation reference.

In one embodiment, the disclosed design of the skid reduces the form drag of the skid. In one embodiment, the disclosed skid incorporates a sliding section (see FIG. 1E) on a forward portion of the skid that moves forward to provide a handling bay for the manipulator to recover and deploy seismic nodes to and from the skid. The sliding section may be pushed forward by the manipulator and when the manipulator is recovered into the skid the sliding section can freely slide back into position. Alternatively, the handling may be opened/closed automatically by a separate motor or gear system or even closed with water pressure. Such a design effectively closes off the inside of the skid to prevent marine life entering and reducing drag as the AUV is travelling subsea.

In one embodiment, the skid may incorporate a system to control buoyancy so that the AUV can maintain a near even trim and a near neutral buoyancy (+/−25 kg) throughout the dive, despite the variation in payload as the nodes are recovered or deployed. Such a system may be referred to as a variable buoyancy system, or VBS. In one embodiment, the VBS is configured from multiple pipes that work in parallel and are specially arranged to maintain the center of buoyancy (COB) near vertically above the center of gravity (COG). These pipes may be positioned on the sides of the AUV and/or underneath the AUV, by being located within or at different parts of the skid. The residual moment between these positions is handled by the use of vertical thrusters on the AUV that automatically control the trim and roll of the AUV to keep the AUV orientation near horizontal. In one embodiment, FIGS. 1A-1D illustrate pipes 133 of the VBS according to one embodiment. In another embodiment, FIG. 2A illustrates variable buoyancy system 215. Limited power supply for the skid and AUV is typically an issue, and requires optimized design of the AUV and skid. Location of the seismic nodes, VBS response, drag of the AUV and skid, and positions of the vertical and horizontal thrusters on the AUV are all important elements of the disclosed embodiment. In some embodiments, the disclosed VBS is part of the AUV as opposed to the node skid itself.

In one embodiment, the disclosed skid comprises a plurality of pressure chambers configured to input and output water from the chambers to vary the mass of the node skid. In one embodiment, the VBS comprises a plurality of pressurized chambers, tubes, vessels, or pipes arranged horizontally along the skid and running across the length of the skid, such that a metered water pump may deliver a mass of water into and out of the pipes to account for the node payload. In one embodiment, the pipes are positioned between the lateral thrusters of the AUV on the underside of the skid, but in other embodiments may be the top, bottom, or side of the AUV and/or skid. The pipes may be formed of aluminum or titanium and may have threaded end caps. The pipes may be arranged to optimize the Center of Gravity (CoG) of the mass that is added to correspond to maintaining the time of the vehicle. For example, as the seismic nodes move forward within the skid, the Center of Balance (CoB) is aligned with the CoG of the weight of the nodes. In one embodiment, a weight of water equivalent to a weight of a seismic node is injected into the pipes as each node is deployed, and in reverse, water is ejected out of the pipes as each node is recovered. In one embodiment, the VBS uses a positive displacement pump (such as a high-pressure piston pump or screw pump) and sea water to act as a variable mass medium to vary the weight of the skid to account for the node payload. A volume of water is regulated by a motor RPM to match the change in weight required by the skid to maintain buoyancy or trim. The pump may use a torque conversion system to drive the pump with a small motor. Alternatively, to generate a given torque on the pump, the corresponding motor may use a closed loop fluid coupling or pressure intensification approach. In one embodiment, each horizontal pipe has an internal floating piston that separates the compressed gas from the seawater. In one embodiment, one or more dump valves may be utilized to relieve internal pressure when the skid is being recovered to the back deck of the marine vessel.

### Deployment and Retrieval System

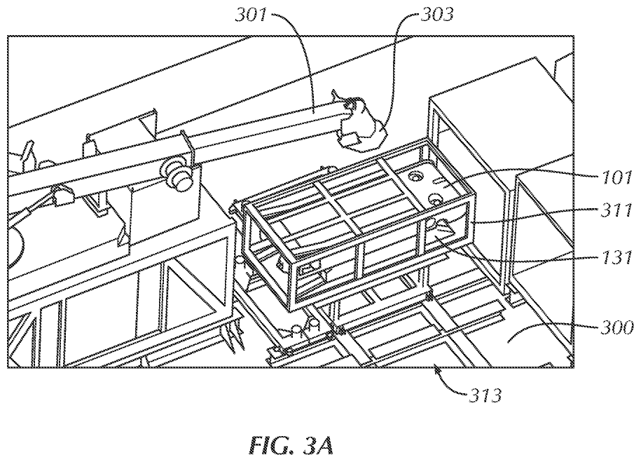

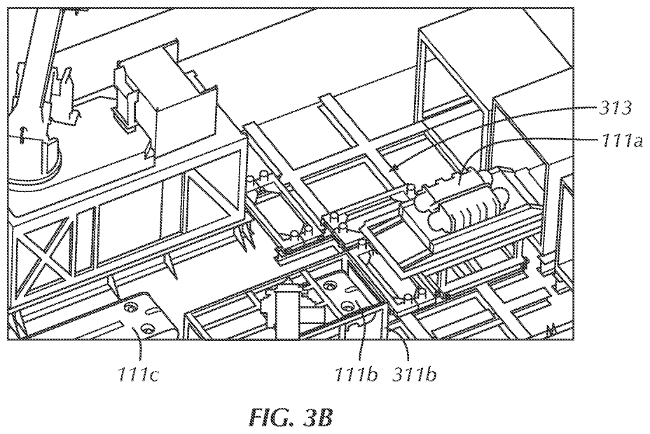

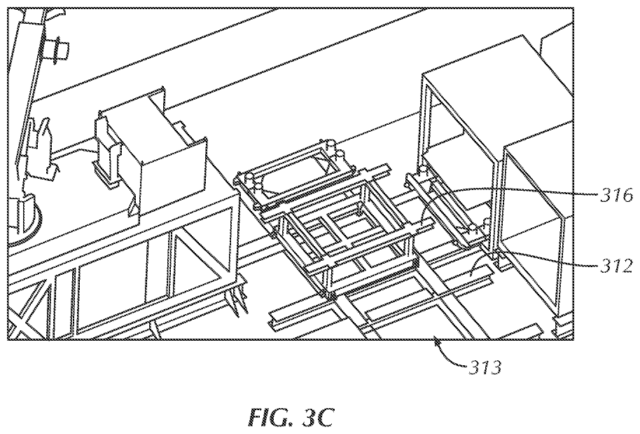

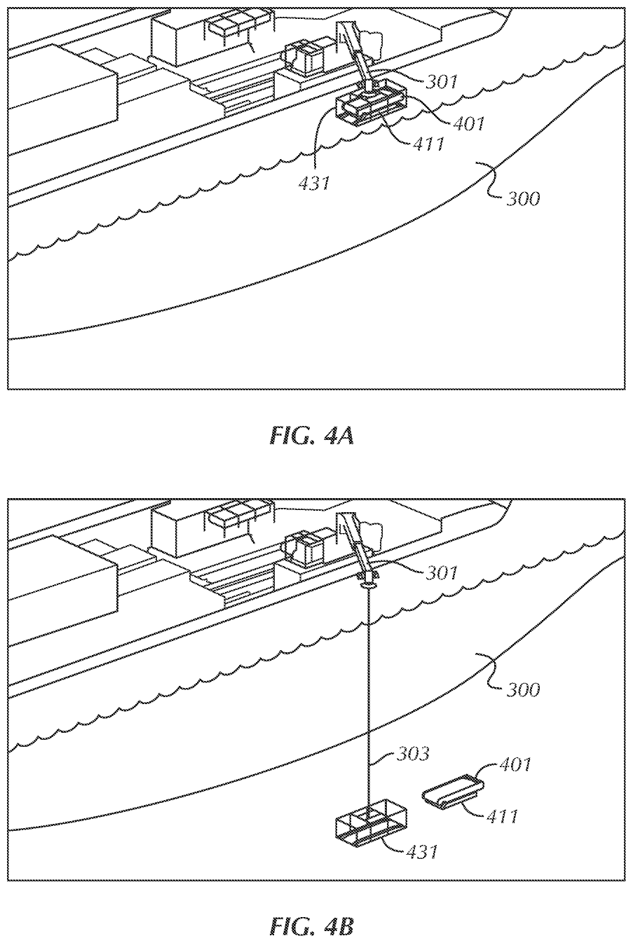

In one embodiment, the disclosed AUV (and coupled node skid) may be deployed by a surface vessel to a subsea depth via a garage or basket. FIGS. 2B and 2C illustrate the schematics of one embodiment of such a basket, AUV, and skid. FIGS. 3A-3C and FIGS. 4A-4B illustrate deployment and handling steps of the garage from a marine surface vessel.

One embodiment of a garage is illustrated in FIGS. 3A and 3B. FIG. 3A illustrates AUV 101 and coupled skid node 131 enclosed within garage, cage, or basket 311 positioned next to manipulator arm 301 on the back deck of marine vessel 300. The surface manipulator arm has an attachment point 303 that can couple to the garage for deploying and retrieving the garage from the back deck of the surface vessel. A garage transport system 313 may be located on the back deck to move the garage from one position on the back deck to another position on the back deck, at which point the AUV may be removed from the garage and seismic nodes removed from the AUV and/or node skid. The manipulator arm is known to those of skill in the art, and can be part of any conventional LARS system for ROV systems on a surface vessel.

Comparing FIGS. 3A and 3B, in FIG. 3B AUV 111a has been removed from the garage and is being transported to a cleaning or storage station. Further, an upper shell of AUV 111a has been removed to show some of the internal components of the AUV. In FIG. 3B, other AUVs are displayed in sequence that are being handled on the back deck. For example, AUV 111b is still contained within garage 311b, and AUV 111c is being transported on transport system 313. FIG. 3C shows AUV handling system 313 without a cage or AUV or skid attached to the handling system. In one embodiment, the handling system comprises a series of rails 312 arranged on the back deck of the vessel to move the AUVs, garages, and/or node skids between different back deck positions. Elevated rail assemblies 316 may be positioned on rails 312 for movement within the transport system and to move nodes, node skids, garages, or AUVs on the back deck of the vessel.

FIGS. 4A-4B illustrate one embodiment of deploying an AUV from a back deck of a marine vessel according to one embodiment of the present disclosure. As displayed in FIGS. 4A and 4B, surface manipulator arm 301 is located near a side of surface vessel 300 for deploying and retrieving garage 431 over a side of the surface vessel. In other embodiments, a moon pool may be located in the center of the vessel and the arm or similar winching system is configured to raise and lower the garage from the middle or bottom of the surface vessel. A plurality of AUVs may be positioned on the deck of the surface vessel on a handling system or transport system. After the AUV (with or without a skid) is positioned within a cage, arm 301 attaches to the cage and moves the cage 431 (and coupled AUV 401 and node skid 411) from the back deck of the vessel to over a side of the vessel. FIG. 4B shows cage 431 being lowered into a body of water via tether 303 and after a point where AUV 401 (and coupled node skid 411) has moved away from the cage. Depending on the deployment operation, the cage can stay at a position subsea, can be raised to the surface to obtain another AUV, or a second AUV that is in the ocean can be retrieved into the cage and raised back to the surface vessel. In general, the retrieval operations of the AUV are opposite to that of the deployment method described above.

When lowered from the surface vessel, the AUV may or may not have a coupled node skid that holds a plurality of seismic nodes as described herein. Once lowered from the surface vessel and at a desired subsea position, the AUV may depart from the garage for its mission operation. The garage may stay at that position or be raised to the surface vessel. A second AUV, after completing its subsea mission, may dock with the garage and be recovered to the surface vessel.

In one embodiment, the garage may touchdown on the seabed while the AUV is docked/undocked, while in other embodiments the docking steps may be done at a depth above the seabed. The AUV may automatically enter or leave the garage based on acoustic beacons positioned on the garage for triangulation purposes. In one embodiment, the departing AUV may acoustically communicate with an incoming AUV the garage heading for better positioning of the AUVs. The garage may or may not contain thrusters for better positioning/aligning purposes subsea. The garage may be powered and/or tethered to a surface vessel for power/communications. The garage may have real time video cameras, thrusters, and a manipulator for handling dead AUVs or seismic nodes. The garage may have locking mechanisms to securely transfer an AUV to and from the seabed and the surface vessel.

In one embodiment, when the garage is landed on the back deck, it fully interfaces with a containerized deployment system for handling of the autonomous seismic nodes coupled to the AUV. In one embodiment, a front sliding section of the node skid may be pushed open and the seismic nodes may be placed onto a conveying system that transports the seismic nodes into the back deck containerized system, at which point they can be washed, data downloaded, recharged, and stored. Loading of the node skid is a reverse process using the same equipment.

When a seismic node is placed on the seabed, a picture may be taken by the AUV or node skid of the seismic node during touchdown, which provides additional confirmation of the touchdown position of the seismic node. Such a position may be automatically inputted into the relevant database for the particular node. For the present disclosure, touchdown is the point of contact of a seismic node to the seabed. Once the node is positioned on the seabed, the touchdown position may be automatically recorded (such as by a position fix and/or a picture) and associated with the particular seismic node in a database. In one embodiment, an automated control system—which may be combined with the AUV navigation system—manages the operations of seismic node identification, handling, and placement. For example, for any particular operation, a particular seismic node may be selected by the AUV and the ID and position of seismic nodes on the displayed on a user interface. Such features allow real time knowledge of the position of all seismic nodes during a deployment operation and increased operational control of the deployment and recovery process of the seismic nodes. Such automatic identification, tracking, deployment, and recovery of seismic nodes is more fully described in Applicant's U.S. Patent Application Publication No. 2019/0265378, incorporated herein by reference, which discloses a ROV with a coupled skid.

Once the desired node has been placed on the seabed, the AUV navigation system will automatically guide the AUV to the next seabed position where the next seismic node is to be placed. In one embodiment, each of the predetermined seabed node positions (which may be in the order of hundreds or thousands) has been determined and, based on the desired deployment system, a list of specific actions and/or steps has been generated to compose the most efficient deployment operation and/or scheme of the seismic nodes. In one embodiment, after positioning an AUV over a node position, the AUV may estimate the XY offset and then lock that position into the navigation system of the AUV as a vehicle reference point. As the AUV descends to the seabed (either on deployment or recovery of the seismic node), a manipulator arm may make contact with the target node using onboard IMU and DVL.

### Optical Stereo Photogrammetry

The disclosed AUV and skid utilizes camera technology, the skid manipulator, AUV hovering abilities, and automated control software to correctly position, location, deploy, and retrieve seismic nodes from the seabed. In one embodiment, the use of the AUV to orientate the heading of the seismic node, take a digital picture of the specific seismic node on the seabed (with the landing point in the background), and to categorize all this information on the payload computer for later use are considered important aspects of the present application. In one embodiment, disclosed is a Node Deployment Phase and a Node Recovery Phase.

In one embodiment, for the Node Deployment Phase, the location and positioning of the seismic nodes on the seafloor is achieved by navigating to a Pre-Plot (PP) position determined by the survey designer. When arriving at the PP position, the AUV will descend to the seafloor and hover just above the seabed. The target height above the seabed may be determined by the vertical stroke of the XYZ manipulator and the need to stay off the seabed and maintain bottom track with a Doppler Velocity Log (DVL). In one embodiment, the target height may be up to 50 centimeters above the seabed. In this position the skid manipulator may transfer the seismic node into a position to release from the skid and the AUV will orientate its heading to the desired azimuth just prior to node release. The AUV and/or skid is configured to take pictures of the seismic node after placement on the seabed and record the precise As-Laid (AL) position.

After seismic recording is performed and the seismic nodes need to be recovered, a Node Recovery Phase may begin. In this phase, the AUV (with coupled skid) is programmed to automatically navigate back to the AL position for each seismic node using a combination of Inertial Guidance, DVL corrections, and USBL aiding. When the AUV arrives at the subsea position, in one embodiment an optical 3D Stereo Photogrammetry approach is used to locate the seismic node. Such a procedure is performed by teaching the AUV control system to recognize the unique 3D shape of the particular seismic node, and the processed output of the image provides an XYZ position and an azimuth position relative to the AUV. This optical approach has not previously been performed for the deployment and retrieval of seismic nodes, but may be more fully described in U.S. Patent Publication No. 2003/0231788 and CN103544315A, each incorporated herein by reference.

Upon acquiring the precise position using this optical approach, the AUV will descend and the XYZ manipulator will arrive directly above the seismic node and the AUV on the correct azimuth. In some instances, optical methods may become problematic with high turbidity. However, as the XYZ position should have been captured before turbidity became an issue, the onboard Inertial/DVL poisoning is given priority on final approach to overcome turbidity/visibility issues. In one embodiment, this switching of positioning methods is achieved by measuring the noise within the digital image.

In one embodiment, the stereo photogrammetry system/optical approach is also used in the deployment phase and is not limited for the recovery phase. This optical approach is able to detect variations on the seafloor bathymetry, for example a very rough seabed compared to reference would indicate the presence of a rock, sea creature, or a deep-sea benthic community. Should this type of anomaly be detected at a PP location the AUV is programmed to automatically relocate to a programmed offset position and attempt to repeat the task. Should the same issue be experienced, an acoustic communication may be sent to the surface supervisor and, if required, the problematic PP position will either be skipped or a seabed image could be requested for verification or another offset could be applied until suitable seafloor terrain is obtained. In one embodiment, the AUV may be utilized to image the seabed by utilizing point cloud recognition for characterization purposes of the seabed, such that the seabed may be scanned by the cameras by utilizing stereo photogrammetry/optical approaches as disclosed herein.

### Emergency AUV Recovery

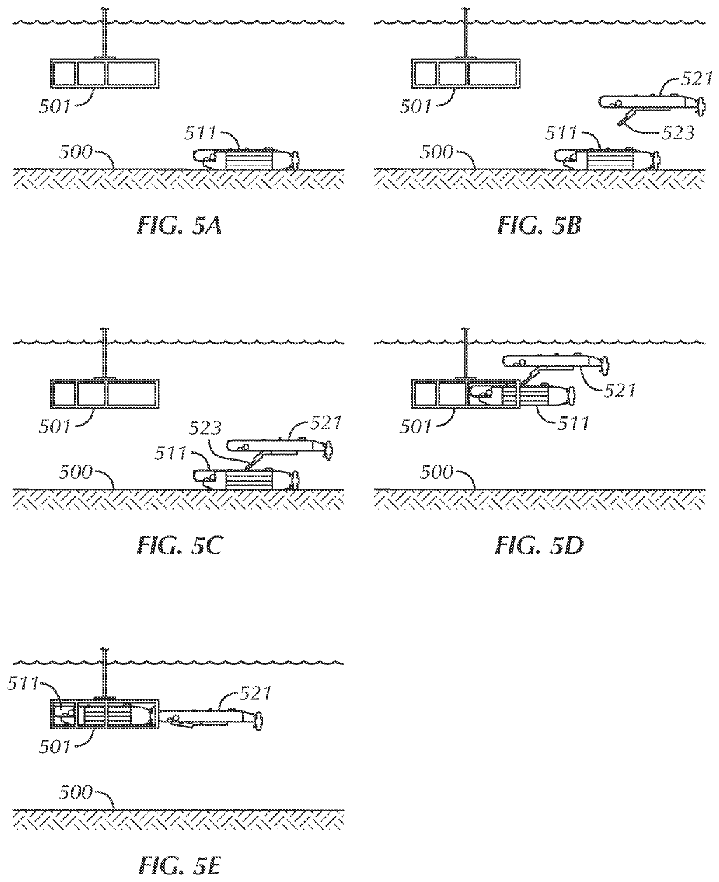

In one embodiment, disclosed is a method for the emergency recovery of an inoperable or dead AUV. One embodiment of such a method is disclosed in FIGS. 5A-5E. In one embodiment, AUVs may lose power or suffer an operation error during subsea operations, causing the AUV to become inoperable on the seabed. In such situations, it is desirable to recover the AUV in an efficient and effective manner. In one embodiment, the surface vessel may contain a spare AUV or ROV coupled to a manipulator skid. This spare sub may be deployed to the seabed to recover the inoperable AUV into the spare garage on the manipular skid.

FIG. 5A illustrates a dead AUV on the seabed. A garage/basket 501 may be deployed to seabed 500 from a surface vessel near a position of dead AUV 511. The deployed garage 501 may also include a second AUV or sub (i.e., a rescue sub) equipped with a manipulator skid. FIGS. 5B and 5C illustrate rescue sub with coupled skid. Rescue sub 521 may or may not include a tether to the surface vessel. Rescue sub 521 may attach to and/or grab the dead AUV by use of manipulator 523. FIG. 5B illustrates a schematic where rescue sub 521 is hovering over dead AUV 511, and FIG. 5C illustrates a schematic where the rescue sub has coupled to the dead AUV via the manipulator arm. FIG. 5D illustrates rescue sub 521 guiding dead AUV 511 into garage 501 using manual or automatic piloting. FIG. 5E illustrates dead AUV 511 being locked and/or secured in place within garage 501. Once the dead AUV is secured within the garage, the coupled rescue sub and garage may be raised to the surface vessel. In one embodiment, the rescue sub may be an AUV or an unmanned underwater vehicle (UUV), and in one embodiment may be the Orion Manipulator skid piloted manually via fiber optic tether.

Many other variations in the overall configuration of the skid, garage, and AUV are possible within the scope of the invention. For example, the skid and AUV may be integrated such that it is considered as a single unit. The skid may be removably attached to the AUV, permanently attached to the AUV, or embedded or integrated within the AUV. In some embodiments, a skid may not be utilized and the AUV may be configured with the variable buoyancy system and a node storage compartment for storage and handling of the seismic nodes. A manipulator arm may be located on the skid or the AUV. The skid and garage may be self-powered or may be powered by the AUV. The skid and/or AUV may comprise one or more cameras configured to take pictures of the seabed and/or the seismic nodes. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A subsea system for the subsea transfer of a plurality of ocean bottom seismic nodes, comprising
an autonomous underwater vehicle (AUV) comprising a power source and a plurality of thrusters; and
a skid configured to be removably attached to the AUV, wherein the skid is configured to hold a plurality of ocean bottom seismic nodes, wherein the skid comprises a node manipulator configured to transfer each of the plurality of seismic nodes to and from the seabed, wherein the skid comprises a variable buoyancy system (VBS).

2. The system of claim 1, wherein the VBS comprises a plurality of pipes and a positive displacement pump, wherein the VBS is configured to control a buoyancy of the skid based on a payload of the skid.

3. The system of claim 1, further comprising an AUV garage configured to be raised to and lowered from a surface vessel and the seabed, wherein the AUV garage is configured to hold the AUV and the skid.

4. A method for the deployment of a plurality of ocean bottom seismic nodes on or near the seabed, comprising
deploying an autonomous underwater vehicle (AUV) from a back deck of a marine surface vessel, wherein the AUV is coupled to a node skid comprising a plurality of ocean bottom seismic nodes;
automatically locating a pre-plot position for each of the plurality of ocean bottom seismic nodes;
automatically positioning the AUV proximate to the pre-plot position;
automatically deploying a selected one of the plurality of ocean bottom seismic nodes at the pre-plot position;
automatically recording a touchdown position of the deployed seismic node; and
automatically adjusting a buoyancy of the node skid based on a node payload of the node skid to maintain a substantially neutral buoyancy in water.

5. The method of claim 4, wherein the adjusting buoyancy step comprises injecting water into one or more pressurized chambers of the node skid to vary the weight of the skid to account for the node payload.

6. The method of claim 4, wherein the touchdown position comprises position coordinates, depth, and azimuth of the node.

7. The method of claim 4, further comprising automatically associating the touchdown position of the node with a unique identification number of the node.

8. The method of claim 4, wherein the recording step comprises taking a picture of the node on the seabed.

9. The method of claim 4, further comprising deploying the AUV and the node skid from the surface vessel in an AUV garage, wherein the AUV garage is configured to be raised and lowered from the surface vessel.

10. The method of claim 4, further comprising utilizing one or more cameras of the AUV as a multi-beam echo sounder to scan the seabed.

11. A method for the recovery of a plurality of ocean bottom seismic nodes from the seabed, comprising
positioning an autonomous underwater vehicle (AUV) near the seabed, wherein the AUV is coupled to a node skid configured to hold a plurality of ocean bottom seismic nodes;
automatically locating a seabed position for each of the plurality of ocean bottom seismic nodes;
automatically positioning the AUV proximate to the seabed position for each of the plurality of ocean bottom seismic nodes;
automatically recovering each of the plurality of seismic nodes into the node skid by a manipulator arm; and
automatically adjusting a buoyancy of the node skid based on a node payload of the node skid to maintain a substantially neutral buoyancy in water.

12. The method of claim 11, wherein the adjusting buoyancy step comprises removing water from one or more pressurized chambers of the node skid to vary the weight of the skid to account for the node payload.

13. The method of claim 11, further comprising utilizing one or more cameras of the AUV to automatically locate each of the plurality of ocean bottom seismic nodes on the seabed.

14. The method of claim 11, further comprising utilizing one or more cameras of the AUV to determine the orientation of each of the plurality of ocean bottom seismic nodes on the seabed.

15. The method of claim 11, further comprising utilizing one or more cameras of the AUV as a multi-beam echo sounder to scan the seabed.

16. A method for recovery of a dead autonomous underwater vehicle (AUV) from on or near the seabed, comprising
deploying a garage from a back deck of a marine surface vessel at a position proximate to the seabed;
deploying an unmanned underwater vehicle (UUV) from the back deck of the marine surface vessel;
positioning the UUV near the dead AUV;
coupling the UUV to the dead AUV;
coupling the dead AUV to the garage; and
raising the garage to the back deck of the marine surface vessel with the coupled dead AUV.

17. The method of claim 16, further comprising deploying the UUV in the garage from the back deck of the marine vessel.

18. The method of claim 16, wherein the coupling the dead AUV to the garage step comprises positioning the dead AUV within the garage by the UUV.

19. A method for imaging the seabed, comprising
positioning an autonomous underwater vehicle (AUV) near the seabed, wherein the AUV comprises a power source, a plurality of thrusters, and a plurality of cameras;
scanning the seabed by utilizing stereo photogrammetry based on one or more camera images obtained by the plurality of cameras;
imaging the seabed by utilizing point cloud recognition; and
identifying objects on the seabed by using a neural network based on the one or more camera images.

20. An autonomous underwater vehicle (AUV) for the subsea transfer of a plurality of ocean bottom seismic nodes, comprising
a power source;
a propulsion system configured to propel and steer the AUV while travelling underwater, wherein the propulsion system comprises a plurality of thrusters; and
a variable buoyancy system (VBS) configured to control a buoyancy of the AUV based on a payload of the AUV,
wherein the AUV is configured to hold a plurality of ocean bottom seismic nodes,
wherein the AUV is configured to move each of the plurality of ocean bottom seismic nodes to and from the seabed by a manipulator arm.

21. A subsea system for the subsea transfer of a plurality of ocean bottom seismic nodes, comprising
an autonomous underwater vehicle (AUV) comprising a power source and a plurality of thrusters; and
a skid embedded to the AUV, wherein the skid is configured to hold a plurality of ocean bottom seismic nodes, wherein the AUV comprises a node manipulator configured to transfer each of the plurality of seismic nodes to and from the seabed, wherein the AUV comprises a variable buoyancy system (VBS) configured to control a buoyancy of the skid based on a payload of the skid.
